(19) United States
(12) Patent Application Publication
(10) Pub. No.: US 2007/0280303 A1
(43) Pub. Date: Dec. 6, 2007

(54) INVENTION CONCERNING EMITTER OF ELECTROMAGNETIC RADIATION, AS WELL AS METHODS FOR THE GENERATION OF POPULATION INVERSIONS IN SAID EMITTER ELEMENTS

(76) Inventors: Stephan W. Koch, Frohnhausen-Oberwalgern (DE); Mackillo Kira, Marburg-Bauerbach (DE)

Correspondence Address: CLARK & BRODY, 1090 VERMONT AVENUE, NW, SUITE 250, WASHINGTON, DC, 20005, US

(21) Appl. No.: 11/632,955

(22) PCT Filed: Jul. 22, 2005
(86) PCT No.: PCT/DE05/01305

§ 371 Date: Jun. 25, 2007

(30) Foreign Application Priority Data
Jul. 22, 2004 (DE) 10 2004 035 635.1

(51) Int. Cl. H01S 3/30

(52) U.S. Cl. 372/4

(57) ABSTRACT

A new method for the generation of populations in exciton-p-states is proposed, and, thus, a method for the generation of population inversions of excitons, i.e. between their energetically spaced states in materials, in which excitons (bound electron-hole pairs) can be generated. Furthermore, emitter elements in the form of lasers or amplifiers (exciton THz lasers) or oscillators are proposed, which use the method according to the present invention in order to generate or strengthen electromagnetic radiation, or to use it in the form of a time unit (oscillator), according to the energetic distances of the exciton states.

The invention at hand concerns new types of emitter elements in the form of amplifiers and lasers of electromagnetic radiation, using materials or mixtures of such materials which demonstrate exciton energy states or in which such exciton energy states can be induced, independently of their aggregate state.

The invention furthermore concerns a method for the generation of a population in exciton p-states and the generation of a population inversion in such exciton energy states, as well as the application of this method to the operation of new types of emitter elements in the form of amplifiers and lasers for the creation of electromagnetic radiation.

In the following, excitons are understood to be bound electron-hole pairs. The binding of both the charge carriers of these excitons is caused by the Coulomb interaction force and the exciton energy states are therefore described following the energy level of the hydrogen atom. In the following, exciton binding energy EB is understood to be the binding energy of the 1s-exciton-state.

Transitions between exciton energy states are crucial in the interaction of electromagnetic radiation with solids, in particular within the infrared range with matter, particularly with condensed matter or with solids in order to describe the absorption properties of the matter.

In particular in semiconductors, which also include some organic materials in the solid state, as well as insulators and even gases or inert gases, the excitation of electrons from the highest filled valence band into the empty conduction band, which are separated by a band-gap energy E_{g} of up to several eV, generates a bound electron-hole pair (exciton) through Coulomb interaction between the remaining “hole” in the valence band and an electron in the conduction band. This provides a contribution to the absorption spectrum, alongside other known effects.

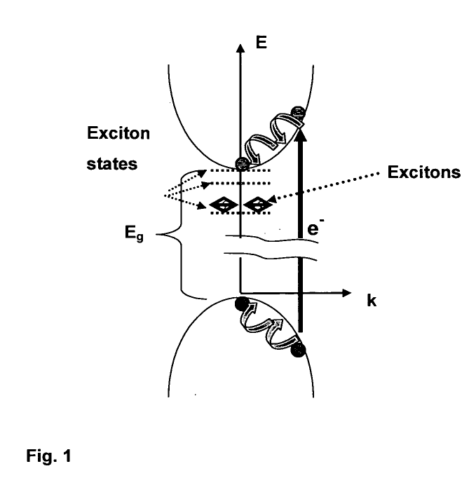

The assigned energy levels or the energy levels of the excitation spectrum of the exciton are, in the case of a semiconductor, depicted in the illustration of the excitation energy E above the impulse (see FIG. 1), just below the energy of the edge of the conduction band, i.e. for example, for a GaAs semiconductor the 1s exciton level is at approx. 1.4 (at room temperature) to 1.5 eV (at lower temperatures), i.e. close to the band-gap energy of GaAs.

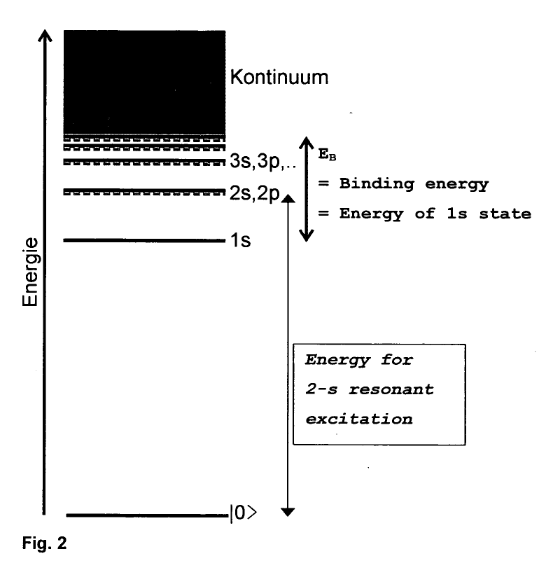

FIG. 2 shows the energy pattern resultant from the hydrogen-like description of the excitons. Binding energies E_{B} for semiconductors which have been experimentally confirmed are in the range of meV (e.g. for InSb: E_{B}=approx. 0.5 meV at E_{g}=approx. 0.2 eV or for CuCl: E_{B}=approx. 110 meV at E_{g}=approx. 3.1 eV), wherein an almost linear correlation between the binding energy and the band-gap energy can be detected. Thus, the binding energies fall to ranges in which, via internal transitions between exciton states, energies in the range of terahertz waves and partially above these can be absorbed or, in the case of inversion population, also emitted.

The range of THz waves is generally accorded the position between microwaves and the infrared range, in the following scale (from low energy to high energy electromagnetic waves), that is from radiowaves, microwaves, infrared, visible, ultraviolet, x-rays.

The range of terahertz waves includes at least the frequency range from 10ˆ10 to 10ˆ13 Hz and therefore corresponds to at least an energy range of 0.04136 to 41.36 meV or at least the wavelength range of 2.998 cm to 2.998 mm.

THz waves are already being used for diverse applications. Within the field of research and commercial development, for example, they are used for the examination of rotation transitions of polar molecules in the gas phase or vibration modes from macro molecules or crystals or processes taking place in superconductors.

From this, it can be assumed that, in the future, the analysis of DNA will likewise be an area of application for THz waves, due to the different refraction indices of single- and double-stranded DNA. Thus, so-called marker-free analysis or diagnostic methods for genetic engineering could be enabled.

A further area of application is environmental analysis, i.e. the proof of the existence of very diverse substances in the air or water or in foodstuffs. It will also be possible to increase quality control of packaged foods during production or storage (without destroying the packaging) using THz waves. In general, THz imaging in two or three dimensions (i.e. a two or three dimensional picture, THz imaging or THz tomography) is also possible by x-raying even expanded objects point for point using THz waves. An English research team successfully proved the existence of a relatively frequent skin cancer type with a high degree of certainty by x-raying human skin two dimensionally. THz waves in THz tomography can also be used in the field of security technology, for example in x-raying luggage.

In the field of communication THz waves can be utilized as carrier frequencies for wireless communication, e.g. in mobile devices. Starting from the current “Bluetooth” standard at a frequency of 2.45 GHz, it will be possible in the near future to operate radio systems at 50 or 100 GHz and, using THz waves, at 1000 GHz, which have a significantly higher transmission rate than “Bluetooth”.

In the following, the term THz or terahertz will be used as a synonym for the further area of the whole frequency range, which energetically corresponds to the transition between two exciton states of any materials and systems, which either feature or can form exciton states.

For all these applications the availability of reasonably priced THz emitters in the form of amplifiers or lasers is crucial.

### TECHNICAL STATE OF THE ART

In the area of research, several recently conducted experiments used terahertz (THz) radiation fields in order to directly examine optically generated many-particle systems. This method had been used until now in order to examine THz conductivity [3], plasmons [4] and the formation of bound excitons [5].

Thus, in 2002 it was possible in [5] (R. A. Kaindi et al.) to prove the population of the 1s exciton level with incoherent excitons, using GaAs multiple quantum wells as a test system. The population of this level was achieved via optical non-resonant excitation, i.e. through excitation of the continuum of unbound electron-hole pair states, i.e. in the conduction band of the test system, using a near-infrared (800 nm) laser pulse of a duration of 1 ps. Due to the Coulomb attraction between the positively charged holes and the negatively charged electrons, electron-hole pairs bound to phonons and defects are formed, as a result of the scattering, from the optically excited unbound electron-hole pairs. The electron-hole pairs bound to phonons and defects are exciton populations in the 1s state, which lies energetically below the conduction band of the semiconductor or below the continuum of the free electron-hole pair states in the GaAs quantum well test system. Then, after different waiting times of approx. 1 to over 1,000 ps, the optically excited test system was exposed to a broadband THz pulse with an impulse duration of 500 fs (wavelength approx. 100-300 μm), in order to test the degrees of freedom of the previously formed exciton populations. At waiting times of approx. 1000 ps for the system described above, a transition from the 1s-state to the 2p-exciton-state of the system at an energy of approx. 7 meV was able to be determined.

The method described above in [5] for the population of an exciton state (of the 1s-state) and the method from [5], which basically corresponds to the aforementioned method with the difference of the direct optical excitation into the 1s-state, as well as the generally known 2-photon-absorption for the population of p-states as well and the likewise generally known conversion between orthoexcitons and paraexcitons in materials such as Cu₂O, are the only methods known so far for the population of an exciton state

Apart from the method for generating THz radiation through mixing two slightly opposed laser pulses in the optical area used in the field of basic research, tuneable THz sources were developed in the area of research, predominantly for spectroscopic purposes, comprising the “free electron laser” [6], “quantum-cascade laser” [7] or sources which use the difference-frequency method to generate THz [8]. The latter method has been described, for example, in Martin Hofmann et al. [9].

Semiconductor emitter elements are already known in the technical field for the generation of radiation in the range of THz. Semiconductor emitter elements are particularly known as so-called semiconductor diodes or also in semiconductor diode lasers. Their functioning principle is based on the following: conductor and valence electrons—which are separated by a band-gap in the energy band of the semiconductor—are injected into an active layer—formed through a pn transition—and then recombine releasing electromagnetic radiation.

A semiconductor emitter element, which is suitable for emission in the far-infrared spectrum, is known from DE 101 22 072 A1 (Infineon). The emitter element, stated there, features a first semiconductor layer system with at least one first semiconductor layer located on a first conductive layer and a second semiconductor layer on, with quantum dots formed therein, a second semiconductor layer system which has grown on the first semiconductor layer system, with a second conductive layer grown on a third semiconductor layer and a control element to put voltage pulses between the first and second conductive layer, wherein the tunneling of electrons is prevented by the first semiconductor layer. The quantum dots have the purpose—in a known way—of forming energy spectra for the charge carriers enclosed therein.

Cited there [11] is a further known variation of semiconductor emitter elements for emission in the far-infrared spectrum, which is known as the so-called “quantum cascade laser”. In the case of these “quantum cascade lasers”, two dimensional electron systems, formed at the border areas of semiconductor heterostructures, create a restriction of the movement of electrons in order to enable electronic transitions between discrete energy levels in the conduction band.

Devices for the emission of THz waves are also known in the field of technology which utilize the difference-frequency method. One example thereof is DE 102 17 826 A1 (Mitsubishi Denki), in which two exciting laser-light sources with different emission wavelengths and a non-linear wavelength transformer device are arranged in such a way that both the optical axes of the emission direction overlap with both wavelengths in the area of the transformer device in such a way that a terahertz beam (the difference between the two wavelengths of the exciting lasers) is radiated in a coaxial direction in relation to both the optical axes.

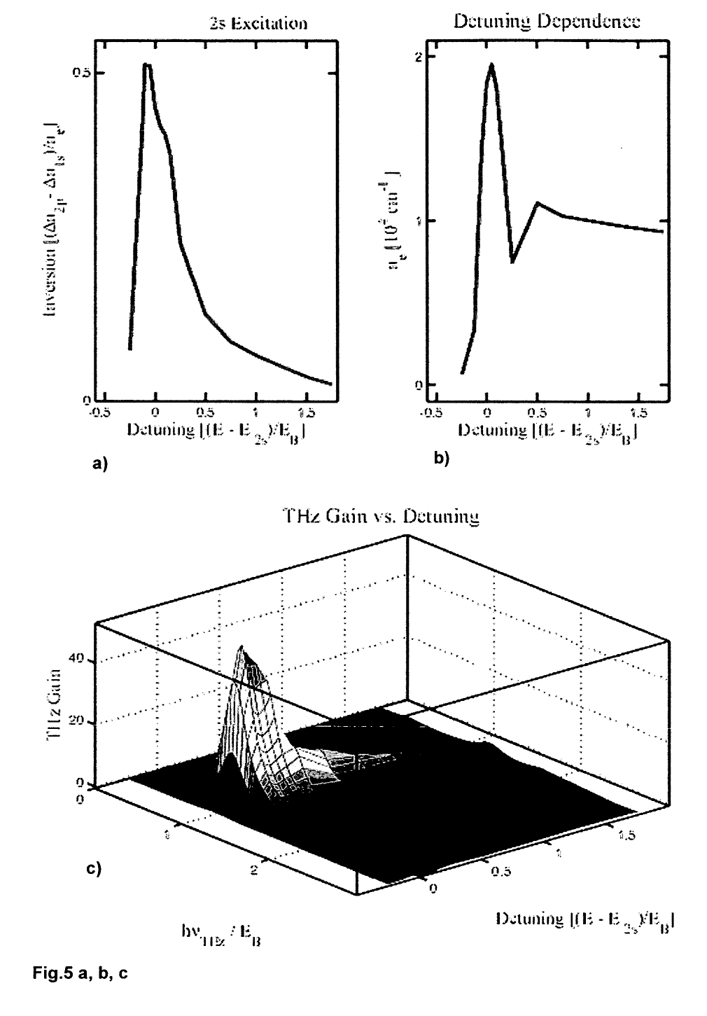

Furthermore, sources of THz waves are known which are based on photoconductive substances. As described, e.g. in DE 102 17 826 A1 (FIG. 5 there, quote from [12]), these feature a photoconductive thin film out of a semiconductor and a gap, to which a direct current voltage source is connected, as well as a dipole antenna, so that free carriers are generated when a laser beam hits the semiconductor (thin film) with an energy which is higher than the band gap of the semiconductor. These free carriers in turn cause pulse-like electricity as a result of the voltage at the gap, resulting in the transmission of an electromagnetic terahertz wave. It is also known that continuous terahertz waves can be generated by optically mixing the beams of two continuously working lasers with different wavelengths on a photoconductive device, forming a mixed wave (beat) so that this wave lies within the range of terahertz.

An apparatus for the generation of electromagnetic energy is known from the patent specification U.S. Pat. No. 2,879,439 (“Production of Electromagnetic Energy”, inventor Charles H. Townes), granted on Mar. 24, 1959, comprising an ensemble of oscillating particles, which normally are in a thermal state of equilibrium in at least two different and discrete energy states and are able to change from one state to another by release of energy and comprising means able to produce an unstable non-equilibrium distribution of particles in the at least two energy states, wherein the means for the generation of an unstable non-equilibrium distribution are suitable for the radiation of electromagnetic energy at a frequency, which corresponds to the difference between the at least two energy states; furthermore, comprising an oscillating electromagnetic circulation with a working frequency range which corresponds to the frequency of electromagnetic energy, and comprising means to transfer the emitted energy into the electromagnetic circulation and comprising means to extract energy from the electromagnetic circulation.

The aforementioned specification refers mainly to the knowledge emerging at that time of the MASER (Microwave Amplification by Stimulated Emission of Radiation), in particular to molecular beam masers, in which the “excitation” or the inversion of population levels into the discrete energy states took place mainly via the separation of one molecular beam into an excited and an unexcited partial beam by means of magnetic fields.

Methods for generating a population inversion and its use in a device for “energizing” mainly in chemical reactions, such as dissociation or exothermal reactions, are also known from the patent specification U.S. Pat. No. 4,161,436 (“Method of Energizing a Material”, inventor Gordon Gould) based on U.S. Pat. No. 804,539 from Apr. 6, 1959, granted on Apr. 26, 1988.

In the aforementioned patent specification the inversion of the populations states in gases (as active medium) is generated, e.g. through irradiation with glow-discharge lamps (whereby the atoms of the glow-discharge lamp are excited by impacting with electrons resulting from the discharge, “first-order impact”) or through direct discharges within the gas of the active medium (e.g. through radio waves) or through “second order” impacts between the atoms of a first gas and those of the gas acting as the active medium (e.g. Na and Hg). In both methods where impacts are used for excitation, populations were also able to be generated in such energy levels which can not be populated by photoexcitation due to the rules of selection for angular momentum.

Furthermore, a method and an arrangement for the generation of population inversion and laser activity in the x-ray and vacuum ultraviolet spectral range is known from DD 268 091 A1 (Academy of Science of the GDR—Akademie der Wissenschaften der DDR). In the method described there, plasmas which have been generated by laser radiation are used, wherein two plasmas are generated independently of each other in terms of time and space, and have opposing expansion directions, with one plasma serving as a heat sink to cool the other plasma while at the same time maintaining the necessary electron density, wherein the area of density in which inversion takes place is enlarged.

In neither of the two previously mentioned US and DD patent specifications, however, are exciton states, i.e. energy states of bound electron-hole pairs, mentioned.

Altogether, no patent specifications or research results, not even in the current literature, are known, which pursue the idea to use the energy levels of the exciton states, which are usually approximated through those of the hydrogen atom, in materials in the form of solids, such as e.g. semiconductors, liquids or gases or their changed states, such as superfluity liquids or plasmas, in order to generate a population inversion (as compared to the thermal equilibrium) through direct optical excitation, i.e. through the excitation of a s-type polarization and the transition thereof through Coulomb interaction for the generation of an exciton population in a p-state, in order, finally, to generate or amplify electromagnet radiation, in particular in the range of terahertz waves or adjacent frequency ranges.

This is hardly surprising when one considers that it has only been in recent years decisive steps towards have been taken in order to achieve the aim to understand the creation of excitons. There are multiple reasons for this; however, for the experimental field it has to be stated that one of these reasons was the lack of suitable spectroscopic methods, i.e. direct THz spectroscopy in well characterized test systems.

One of the reasons in the theoretical field is that the description of the Coulomb interaction, while at the same time taking the interaction of the electrons and holes with the photo-field and phonons into consideration, is very difficult and requires complex calculations, in particular with regard to the creation of exciton populations in many-particle systems.

### DISADVANTAGES OF THE TECHNICAL STATE OF THE ART

The known and aforementioned methods to build up exciton populations in p-states, in particular the 2-photon-absorption, are not well suited for practical applications, as light sources with energies in the range of half the band-gap would be necessary, which are generally not available commercially, or if at all available, very difficult to obtain.

In the aforementioned emitter elements, many different semiconductor materials with a relatively large band-gap can be used in the range of the far-infrared spectrum; however, all aforementioned semiconductor emitter elements feature the disadvantage that the production process is very complex and costly (production of heterostructures, i.e. thin layers with dimensions in the range of nm).

The other aforementioned devices or methods are also complex and costly in terms of apparatus or other factors, as, e.g., two light sources and further elements, such as a phase matching device etc. are necessary.

None of the named devices and methods are able to generate population inversions in excitons or transitions between energy states of excitons in a simple and therefore controllable way or using low energy input.

### AIM

The aim of the current invention is therefore to provide a method for the generation of a population or the increase of a population of excitons in the p-state and, thus, also a method for the generation of a population inversion in exciton states, which both avoid the above mentioned disadvantages.

Further aims of the current invention—using the methods—are to provide emitters with a simple construction, also in the form of amplifiers or lasers, for the emission of electromagnetic radiation within the range of energy differences between exciton states.

### ACHIEVEMENT OF THE AIM

The first of these aims (provision of a method for the simple population of excitons in the p-state) is achieved according to the present invention by the method according to claim 1.

The second of these aims (provision of a method for the generation of a population inversion between exciton states) is achieved according to the present invention by the method according to claim 5.

The third and fourth of these aims are achieved according to the present invention through the subject matters of claims 11 to 15.

It is known that the resonant laser excitation of semiconductors induces a coherent “interband polarization” between the conduction band electron states and the valence band hole states. In this context the word coherent means that all these processes have a clearly defined phase relationship, which is imposed by the excitating laser pulse. This phase relationship can be observed in the form of an optical polarization of the material, which in turn is re-coupled to the excitation laser pulse via the Maxwell equations. Such coherence can, however, in general only be maintained for a certain period of time (as a rule for several picoseconds) as phase destroying processes are always taking place at the same time. In solids it is mainly the long-range Coulomb interaction between all electrons and holes and the interaction between charge carriers and lattice vibrations (phonons), as well as the frequently existing disorder effects in real systems, which cause the decay of the polarization. In general, the density of electrons and holes remain intact in the excited state following such a pulse and the resulting decay of the polarization.

Furthermore, it is known that this “optical polarization” can be converted into incoherent populations of unbound or/and bound electron-hole pairs (excitons) through interaction and scattering processes.

Although the excitonic properties of the coherent polarization are fairly well understood, the examination of the transition of the coherent polarization into incoherent many-particle systems forms an active field of current research.

### CORE ELEMENTS OF THE INVENTION

Surprisingly, it has now been detected that excitonic coherences, i.e. the optical polarization generated by resonant excitation with a strict s-type radial symmetry, can effectively be converted into incoherent p-type populations. Studies show that this result is caused by scattering induced by Coulomb interaction.

Concerning this scattering, it has been found that even a population inversion can occur (as compared to the state of equilibrium) between the exciton 2p-state and the 1s-state and/or further higher p-states and s-states below, which leads to a creation of or/and amplification of a radiation field of electromagnetic radiation, wherein the component of the radiation is generated or/and amplified according to the energy of the transition from each p-state to the s-state.

In order to achieve this new way of generating a population of p-states and thus—due to the type of transition used from p-states to s-states—a population inversion between the p-state and the s-state located below it (e.g. 2p to 1s), it was surprisingly found that in the case of resonant optical excitation of the 2s-state, i.e. the irradiation of light with an energy corresponding to the 2s-resonance (i.e. in the case of a semiconductor, an energy corresponding to the difference between the 2s exciton state and the upper edge of the valence band) or/and the respectively higher s-resonances, although an optical polarization with an s-type symmetry was generated, this was very efficiently converted into a p-type exciton population. As in the thermal equilibrium none or only an insignificant number of excitons are in the 2p-state, in the realization of the method to generate a population in an exciton state (optical excitation with an energy corresponding to the 2s resonance or a higher s resonance), a population of the 2p-state or a higher p-state and, hence, also a method for the generation of a population inversion is carried out as well.

Hereby, it was found that the method was in principle also successful with an excitation at higher energy levels, about one and a half or twice the exciton binding energy (which corresponds to the binding energy of the 1s-state) above the 2s-resonance or a correspondingly higher s-resonance. However, this features significantly less yields with regard to achieving a population inversion in the relationship 2p to 1s or 3p to 1s etc.

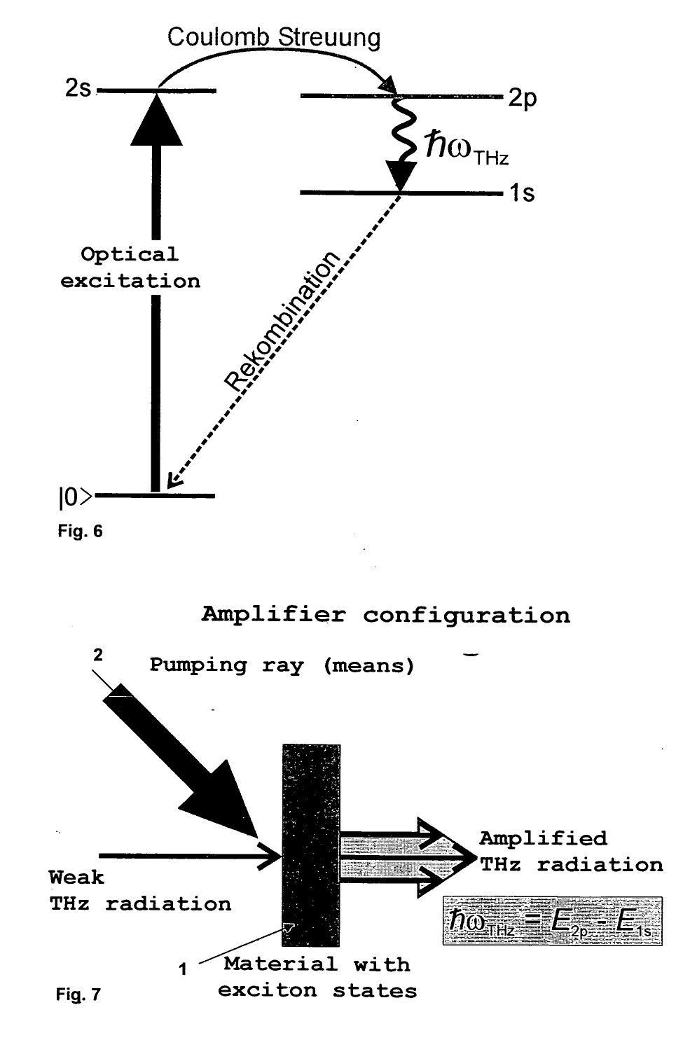

In order to carry out the method, the chosen material, suitable for the formation of excitons, is exposed to an optical excitation [step 1, optical excitation, in FIG. 6], so that an optical polarization is induced with a 2s-type symmetry, which is achieved through simple irradiation with energy corresponding to the 2s-resonance. This s-type polarization is then partly converted into a 2p-type population through Coulomb interaction effects, which inevitably arise. [Step 2, Coulomb scattering].

This method according to the present invention also leads through excitation to populations of the 3s-resonance and the 4s-resonance and thus to a population inversion as compared to the state of equilibrium and as compared with the 1s-state or 2s-state or both.

Moreover, the excitation does not have to take place exactly at the 2s-resonance, but can also be out of tune up to as much as twice the exciton-binding energy. The mechanism does not work, however, if the detuning is too great (non-resonant excitation), because the optical excitation is not directly converted into excitons, but into unbound electrons and holes.

This population can be decayed again to the 1s state through spontaneous emission or stimulated emission with radiation corresponding to the difference between the 2p-1s states or 3p-1s states etc., if given the corresponding electromagnetic radiation 1s [step 3, emission of THz radiation].

The charge carriers' density can be decayed, and with it the bound electron-hole pairs (excitons), through spontaneous recombination of electron-hole pairs of the material [step 4, recombination].

As the excitation according to the present invention into the 2s-state with a suitable choice of the excitation intensity leads only insignificantly to the population of the 1s-state, and as populations in the 1s exciton state decay in a period of nanoseconds, whereas the transition from 2s- to the 2p-exciton-state (as described above) takes place faster, i.e. in the range of picoseconds to femtoseconds, a significant inversion in p-exciton-states can be achieved.

In the literature, the period of time given for the creation of excitons, e.g. in semiconductors using the method of non-resonant excitation of charge carriers into the conduction band and the subsequent scatterings, is given as ranging from 20 ps to several hundreds of picoseconds. Moreover, it can not be expected that in this case significant populations of p-states occur, so that no population inversion can be generated between p-type states and s-type states.

These results are valid for all materials, independently of their aggregate state, insofar as they are able to create bound exciton states, in particular for semiconductor material (direct or indirect semiconductors), including, for example, some organic systems such as polymers or gases at low temperatures.

Due to the common understanding and the existing prejudices, one would have expected that the exciton polarization at the 1s-resonance or 2s-resonance (or at higher s-resonances) would be converted purely into incoherent s-type populations. One could have tried to create a 2p-population or a population in a higher p-exciton-state by means of 2-photon-absorption directly into this state. However, due to the necessary photo-energies required for that purpose—as described above—this is very difficult to achieve and contradicts the advantage of simplicity of the principle discussed here.

In the following, the studies upon which the invention is based will be described.

In studies which analyze the THz or exciton properties of resonantly excited semiconductors, the formation of exciton populations in various quantum states was observed.

A quantum-wire structure served for the examination, wherein the main results were equally able to be confirmed for a quantum-well structure. The chosen material for the observations was GaAs, wherein the dimensions were chosen so that the energy difference between the two lowest exciton-states amounted to 5 meV. The lattice temperature was set at approx. 10 K, so that the only influence expected was that of acoustic phonons.

In order to examine the formation of incoherent excitons in the different quantum states, the analyzed semiconductors were pulsed at an optical excitation corresponding to a time period of 4 ps and examined corresponding to the energy of the 1s- and 2s-resonances. The examinations were repeated at different excitation or “pump” intensities and, for each, the final quasi-stationary exciton-fraction □n_{ñ}n represented with n_{□}=density of excitons in the state _{□}=1s, 2s, . . . and n=value of the (charge) conductor density.

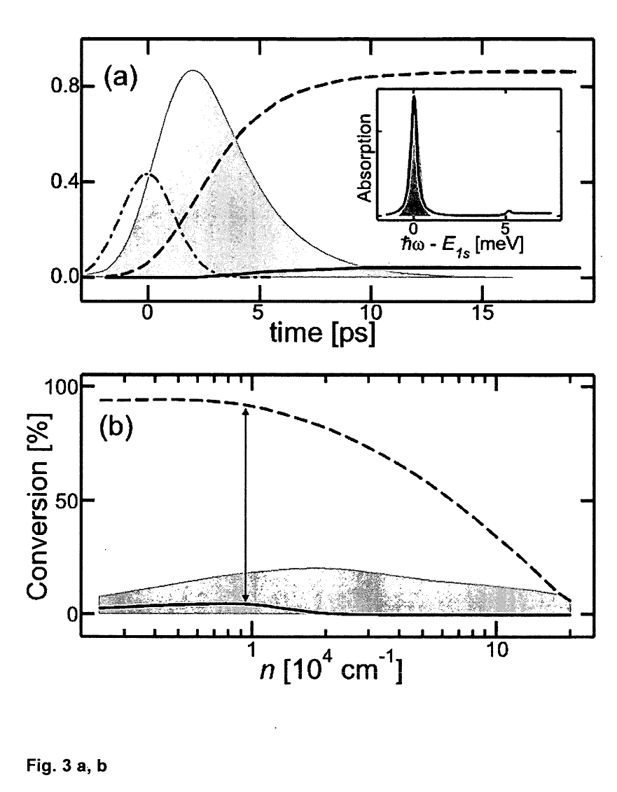

The results therefrom are depicted in FIGS. 3 to 5.

FIG. 3(a): Shows for an excitation at the 1s-exciton resonance by means of a 4 ps laser impulse (dot-dashed line): the temporary development of the optically created polarization [P]² (shaded area), together with incoherent 1s exciton density (dashed line) and 2p exciton density (solid line) [10⁻⁴ cm⁻¹]. The smaller diagram inserted in FIG. 3 shows the pumping (shaded area) and the linear absorption spectrum (solid line); E₁ₛ is the 1s exciton energy.

FIG. 3(b): The efficiency of the transition of the polarization to a population for 1s excitons (dashed line) and 2p excitons (solid line) is plotted as a function of the excitation density n (in 10⁴ cm⁻¹). The arrow shows the density at which the dynamic is shown in 2(a). The shaded area represents the transition efficiency achieved without photon scattering.

FIG. 3a shows the time span of the pump impulse, of the induced optical polarization and the 1s exciton density and the 2p exciton density generated. FIG. 2b shows the relative proportion of excitons in different quantum states, wherein it has to be stated that for the 1s excitation the optical polarization is mainly converted into incoherent 1s excitons—which is hardly surprising according to the current state of knowledge. The proportion of εn_{\tilde{is}}n is well above 90% for low excitation densities n. This large proportion was to be expected as coherent and incoherent 1s excitons feature an excellent energy “match”. However, it must also be stated that at moderate excitation densities above 10⁵ cm⁻¹ the exciton population generated decreases; □n_{\tilde{is}}n is only 40% there. At higher excitation densities □n_{\tilde{is}}n disappears, as the excitons “ionize”.

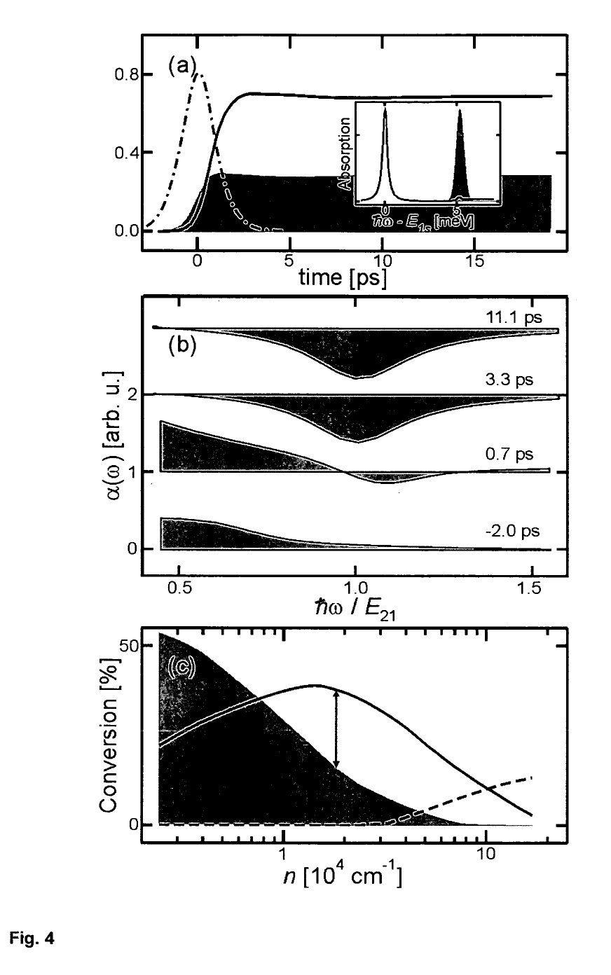

The results for resonant 2s excitation are shown in FIG. 4a, b, c, with FIG. 4c showing the relationships □n_{\tilde{□s}}n, □n_{\tilde{□p}}n and □n_{\tilde{is}}n. For not too high excitation densities n, it has to be stated, that the 2s polarization is converted into a mixture of 2s and 2p populations. Whereas the value of the 2s population decreases monotonically with increasing excitation density, the value of the 2p population initially grows up to 40%, before also falling at higher excitation densities, where the creation of 1s excitons gradually achieves significance (dashed line in 4c).

Through examination of the dynamic of the formation of populations, i.e. through irradiation of the test system with a 150 fs THz pulse, it was possible to determine that, for short periods of time (observation time of up to approx. 11 ps) after excitation, primarily only THz absorption with a maximum at the 1s-2p transition was generated, when the 1s resonance was optically excited. These results have already been confirmed experimentally in [5].

However, at excitation in the 2s resonance, it could be determined that, initially, primarily only 2s excitons are available for a very short period of time after excitation (see FIG. 4a), so that there are only absorption transitions from 2s-state into the higher states, wherein incoherent 2p excitons have already been formed after approx. 3 ps, leading to a significant THz gain through 2p to 1s transitions as a consequence of the population inversion between both these states. By means of calculations independent thereof it was possible to detect that, for the test system “quantum wire”, a relationship of the 2s populations to the 2p populations of 1.36 can be achieved, and that, for the test system “quantum wells”, a relationship of 0.99 can be achieved. At the temperatures studied, practically no excitons in the 2p-state were found in thermal equilibrium, so that the quotient would then be infinite. This means that one can assume for the test systems “quantum well” and “quantum wire”, that, through the method according to the present invention applied to 2s resonance, a population inversion can be generated which has about as many, if not more, excitons in the 2p-state as in the 2s state.

This method for the population of exciton p-states and for the generation of a population inversion is generally applicable to materials or mixtures thereof or systems which allow the formation of excitons (or exciton states), in particular in semiconductors, which also include some organic polymer systems. Due to the way in which the p-states are populated, i.e. due to the fact that s-states are also populated to a small degree, the method according to the present invention is also suitable for the generation of a 2p-state or a higher p-state and is new and inventive according to the above described state of the art when it is considered to be a method for the simultaneous population of s-states and the assigned p-states. The reason for the novelty and inventiveness of this method is the same as that for the method according to the present invention for the population of exciton p-states, as there is no known method—as is the case for the aforementioned method—in which there is an essentially parallel population generation of an s-state and the assigned p-state.

However, it has to be considered that the methods according to the present invention are most effective when relatively clear, spectrally well formed excitonic resonances or exciton energy states exist, which can easily be achieved, e.g., through respective cooling or other measures known, e.g., from spectroscopy.

FIG. 5a, b, c show the extent of the population inversion achievable by the method (“THz gain vs. detuning”) dependent on the “detuning” of the excitation into the 2s excitonic resonance in E_{B} units, i.e. the exciton binding energy (i.e. the 1s exciton binding energy) of the test system examined.

FIG. 5a (top left) shows that the population inversion (2p to 1s) at a detuning (E−E2s)/E_{B} of zero (i.e. at exact resonance) is optimal, i.e. is at a value of more than 0.5 (see y axis for the unit) and is at a value of E=1.5×E_{B} of almost zero.

FIG. 5b (top right) shows the effectiveness of the production of charge carriers as a function of the detuning. I.e., it is directly proportional to the absorption spectrum of the test system studied.

These results are also transferable to other systems or materials—in particular in terms of the limitation of the value at which the method still functions, i.e. at excitations with a detuning at one or two times the level of the 2s exciton binding energy.

FIG. 5c shows the amount of the population inversion “THz gain” in arbitrary units for the test system examined (quantum wire). This illustration is advantageous, as the absolute gain depends on things such as the number of quantum films (in a 2D system), excitation intensity etc.

Advantageous practical embodiments will be described in the following and in the text sections to follow—without being conclusive.

The following shows schematically:

FIG. 1: the excitation and formation of excitons in a semiconductor or a semiconductor quantum structure

FIG. 2: the energy level of an exciton

FIG. 3: the results of the examinations on GaAs quantum structures (quantum wire) at excitation in the 1s excitonic resonance,

FIG. 4: as in FIG. 3, however at excitation in the 2s excitonic resonance

FIG. 5: population inversion (top left), excitation density generated (top right) and THz gain (bottom) as a function of the detuning of the excitation laser with regard to the 2s excitation resonance

FIG. 6: the level pattern of an “exciton THz laser” or THz amplifier

FIG. 7: a principle structure of an “exciton THz amplifier”

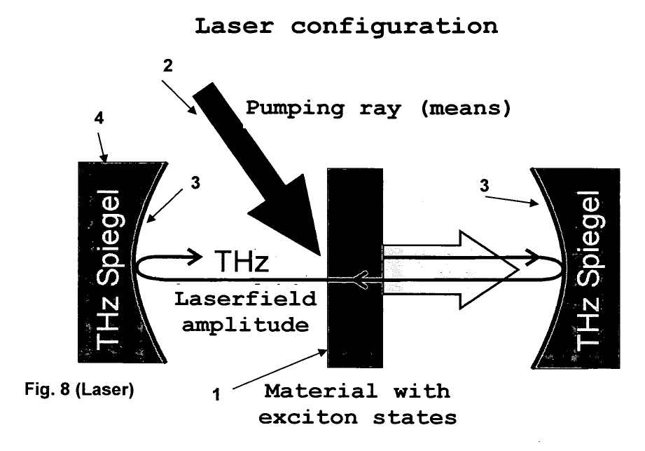

FIG. 8: a principle structure of an “exciton THz laser”

The term “exciton emitter” (amplifier or laser) will be used in the following, on the one hand to distinguish it from an “exciton laser”, which according to the general understanding of the term supplies only energies which correspond to a recombination of excitons, and on the other hand to find a shorter term for a frequency range which corresponds to the energy differences capable of being generated between 2 exciton states (see the aforementioned definition of “THz”).

FIG. 1 to FIG. 5 have already been described in text passages above.

FIG. 6 shows the generation of a population inversion according to the present invention and laser or amplifier process in exciton energy states.

FIG. 7 shows schematically the principle configuration for an exciton THz amplifier. Hereby, the electromagnetic radiation in the range of THz, which is to be amplified, is irradiated in the manner known from the laser semiconductor diodes into the semiconductor material, wherein, through population inversion generated between the desired states, an amplification through stimulated emission occurs of exactly the component of the irradiated radiation which corresponds to the energy difference of the generated population inversion. Correspondingly, known optical components such as silicon lenses can be used in order to bundle the emitted radiation or to apply further treatment in a known manner.

FIG. 8 shows a schematic configuration of an exciton THz laser. Hereby, the “pump performance”, in the form of optical energy in a pulsed or cw-form, is radiated in a known manner into a cavity indicated by two reflectors (e.g. made of aluminum or gold). For the generation of the “lasing”, the pump performance is then to be adjusted in a known manner to the permeability of the one decoupling mirror (partial permeability in the range of typically 2-3% or more) and to any other energy losses. Alternatively, the cavity can also be realized through the relevant treatment or coating of the surfaces of the “active material” (semiconductor etc.). The measurements of the cavity (distance of the reflectors) or distance of the surfaces of the active material are to be chosen corresponding to the desired modes or wavelengths in the manner known from the laser diodes.

As a person skilled in the art can immediately see, but is known at least from the field of known semiconductor emitters or laser diodes, this laser can be operated in cw- (continuous wave) mode or in pulsed mode. In this laser, a population of 2p-excitons [step (1) and (2)] is generated by pumping close to the 2s resonance.

A cavity can be built with suitable mirrors (e.g. aluminum or gold) for the corresponding frequency range of the transitions between the exciton states, in which a stimulated emission of electromagnetic radiation of the corresponding transitions between exciton states, corresponding to suitably chosen geometry, can be generated. This is realized through sufficient pump performances, dependent on the transition durations, losses due to mirrors and to other known marginal conditions of common light lasers.

In an advantageous practical embodiment—not depicted here—of an “exciton THz laser”, the use of semiconductors is foreseen as active material for the generation of electromagnetic radiation in the range of exciton states.

A further practical embodiment of an “exciton THz laser” is the use of direct semiconductors, especially preferable due to the higher probability of the transition of a charge carrier into the conduction band through excitation with electromagnetic radiation.

As known by a person skilled in the art, one can also increase the yield for transitions after excitations—with greater effort however—for indirect semiconductors, such as germanium, silicon and gallium phospide (GaP), if, with suitable doping, the transitions take place from or in defects. Radiated transitions with the involvement of defects are important for semiconductor material which is used technically. Such defects are achieved through doping, for example with so-called donators and acceptors. It is known that, apart from a few exceptions, most luminescent diodes are made of A_{III}B_{V} semiconductors or A_{III}B_{V} compounds, such as, for example, GaAs, wherein the corresponding diodes emit electromagnetic radiation in the infrared range. With GaAs in combination with silicon doping, donators result from substitution on gallium sites; acceptors result from mounting on arsenic sites.

A special type of defect is formed when the atom of a host lattice is replaced by another, which is in the same group of the periodical table. Such defects, which are called “isoelectronic”, retain charge carriers as a result of an altered shield of the atomic nucleus, whereas the binding of charge carriers to donators and acceptors occurs as a result of Coulomb forces. For example, nitrogen atoms form isoelectronic defects with acceptor character on phosphorous sites in gallium phosphide (GaP). It is also known that excitons can be bound to isoelectronic defects. That means that such systems are also suitable as active media for the method according to the present invention and the emitter elements according to the present invention. Through the practical choice of the doping elements, the indirect semiconductor material gallium phosphide (GaP) can also be used as active material for emitter elements according to the present invention.

In a further advantageous practical embodiment of an “exciton THz laser”—not depicted here—the use of nano-structured material, preferably of semiconductors and especially preferred in the form of a quasi two-dimensional quantum film, is foreseen as active material for the generation of electromagnetic radiation in the range of exciton states. Thus, sharper, more pronounced excitonic resonances, and therefore higher population inversions, can be achieved than with volume semiconductors.

In a further advantageous practical embodiment of an “exciton THz laser”—not depicted here—the use of such materials is foreseen, as an active material for the generation of electromagnetic radiation in the range of exciton states, which feature a variation in the distances between exciton states under the influence of temperature fluctuations or/and fluctuations in pressure. Such materials are, for example, all known materials with excitonic resonances. With them, an “exciton THz laser” with adjustable wavelengths can be produced.

In a further advantageous practical embodiment of an “exciton THz laser”—not depicted here—a cooling device is foreseen in order to shift the exciton energy, i.e. the excitonic resonance, so that the level of 2s-state will also be lowered, however, without changing the energy differences between the exciton states.

Furthermore the cooling has the effect of repressing noise effects, which are, for example, generated by unwanted lattice vibrations.

In a further advantageous practical embodiment of an “exciton THz laser”—not depicted here—a control or/and regulation is foreseen, in order to increase the output of electromagnetic energy, which holds the laser for a certain period of time below the “lasing threshold” in order to then cross it—at least for a short period of time—to achieve a very highly stimulated emission.

In a further advantageous practical embodiment—not depicted here—it is foreseen to apply the method according to the present invention in an oscillator configuration, for instance in order to establish a time measurement system, as is known to the person skilled in the art from other optical or electromagnetic systems, at least, however, known from U.S. Pat. No. 2,879,439.

It is immediately obvious to the person skilled in the art, that the aforementioned practical embodiments of “exciton THz lasers” according to the present invention can be converted, through the simple application of expert knowledge (see FIG. 7), into “exciton THz amplifiers” and therefore in general into “exciton emitter elements” wherein—as the person skilled in the art knows—one must only pay attention to the fact that although an exciton inversion, as described above, must be generated, this must however occur without bringing the material in a cavity.

### LIST OF REFERENCE NUMERALS

1 Active medium

2 Pump device for the generation of excitons

3 Mirror

4 Cavity elements (of the resonator)

### BIBLIOGRAPHY

[3] M. Beard et al., Phys. Rev. B 62,15764 (2000)

[4] R. Huber et al., Nature 414, 286 (2001)

[5] R. A. KaindI et al., Nature 423, 734 (2003)

[6] J. Urata et al., Phys. Rev. Lett. 80, 516 (1998); M. Abo-Bakr et al., Phys. Rev. Lett. 88, 254801 2002)

[7] J. Faist et al., Science 264, 553 (1994); B. S. Williams B S et al., Appl. Phys. Lett 83, 5142 (2003)

[8] T. Kleine-Ostmann et al., Electronics Lett. 37,1461 (2001)

[9] M. Hofman et al., Appl. Phys. Lett., Vol. 84, No. 18, 3585 (2004)

[11] J. Faist et al., Quantum Cascade Laser, Science, Vol. 264, S553-556, 1994.

[12] “Laser Research”, Vol. 26, Nr. 7, pages 515-521, July 1998.

1. Method for the generation of a population in at least one exciton p-state (i.e. energy state, bound electron-hole pairs) comprising the following principle steps:
a) provision of one or more materials, or a mixture of materials, or one material or a material system with a suitable morphology or structure, which can form exciton states,
b) exposure of this material or these materials or the mixture to an optical excitation with an energetic value which lies within the range of a value that corresponds to the energy of the 2s excitonic resonance or a higher s-type state resonance, up to a value which corresponds to the sum of the amount of the 2s or higher excitonic resonance and twice the exciton binding energy (equal to the 1s exciton binding energy) of the respective material in the respective active state.

2. Method according to claim 1, wherein, for the excitation energy in step b), a value is chosen which corresponds to the amount of a value of the 2s excitonic resonance or the chosen higher s excitonic resonance up to 1.5 times, preferably once, particularly preferable up to 0.5 times and very particularly preferable up to 0.25 times the exciton binding energy.

3. Method according to claim 1, wherein the excitation takes place parallel to an energy value corresponding to the 2s excitonic resonance and at least one other energy value corresponding to a higher s excitonic resonance.

4. Method according to claim 1 wherein the excitation is pulsed or continuous, or in the case of a method according to claim 3, where each of the at least one s excitonic resonance.

5. Method for the generation of a population inversion in comparison to the equilibrium state between two energetically spaced exciton states wherein the method is conducted according to the methods in claim 1.

6. Method according to claim 5, wherein the excitation intensity is carried out in an optimized manner with regard to the transition of s-excitons into p-excitons through variation of the excitation intensity (i.e. photons per time unit, or volume unit or area unit of the used material).

7. Method according to claim 1, wherein the method to cause a modification of the distances of the exciton states or of the exciton binding energy is carried out with simultaneous temporary or permanent or permanently repeated execution of modifications or fluctuations in pressure or temperature on the used material.

8. Method according to claim 1, wherein the extent of the population or/and population inversion achieved is monitored during the execution of the method through irradiation of electromagnetic radiation corresponding to the energy distance between the exciton states to be observed, wherein the extent is controlled by the determination of the absorbed or emitted electromagnetic radiation.

9. Method for the generation of a mainly simultaneous population in a 2s-state or higher s-state and the assigned 2p-state or higher p-state wherein the method is carried out according to the methods of claim 1.

10. Method for the generation of a population inversion as compared to the state of equilibrium between two energetically spaced exciton states or for the increase of a population of a 2p-exciton-state or a higher p-exciton-state or the generation of a mainly simultaneous population of a 2s- and 2p- or higher s-state and assigned p-state, wherein the method is carried out according to claim 1, wherein in step a) one or more materials, or a mixture of materials, or a material or material system with suitable morphology or structure is provided which already features a population of at least one, two or more exciton states.

11. Device for carrying out the method according to claim 1, featuring one or more materials, or a mixture of materials, or one material or material system with suitable morphology or structure, in which exciton states are formed or in which exciton states can be formed or in which exciton states are already populated (hereinafter called active material), as well as featuring a means for the pulsed or permanent release of electromagnetic radiation (hereinafter called pump device) onto the aforementioned active material, wherein the pump devices used are arranged in a suitable manner for releasing electromagnetic radiation in the range of 2s excitonic resonance or higher s excitonic resonance up to twice, preferably up to 1.5 times, particularly preferable up to 1.25 times the value of the excitonic binding energy above the 2s excitonic resonance or the higher s excitonic resonance.

12. Device according to claim 11, wherein the pump devices used are arranged in a suitable manner for simultaneously releasing electromagnetic radiation at 2 or more different wavelengths onto the active material, corresponding to 2 or more values in the range of 2s excitonic resonance or higher s excitonic resonance up to twice, preferably up to 1.5 times, particularly preferable up to 1.25 times the value of the excitonic binding energy above the 2s excitonic resonance or the higher s excitonic resonance.

13. Exciton THz amplifier, wherein the amplifier is arranged in a suitable manner to carry out the methods according to claim 5, wherein the amplifier furthermore features one or more materials, or a mixture of materials, or one material or material system with suitable morphology or structure, in which exciton states are formed or in which exciton states can be formed or in which exciton states are already populated (hereinafter called active material), as well as featuring means for the pulsed or permanent release of electromagnetic radiation (hereinafter called pump device) onto the aforementioned active material and the pump devices are arranged in a suitable manner for releasing electromagnetic radiation in the range of 2s excitonic resonance or higher s excitonic resonance up to twice, preferably up to 1.5 times, particularly preferable up to 1.25 times the value of the excitonic binding energy above the 2s excitonic resonance or the higher s excitonic resonance, wherein the active material or a foreseen encirclement of the active material is arranged in a suitable manner for irradiation and emission by means of spontaneous and stimulated emission of the electromagnetic radiation which is to be amplified.

14. Exciton THz laser, wherein the laser comprises an amplifier according to claim 13 and, in addition, features an arrangement of resonators, e.g. in the form of a cavity, wherein the resonator and the reflectors assigned to the resonator (e.g. made of aluminum or gold) are arranged in a suitable manner for the maintenance of a laser field arising from the energy differences of the exciton states by means of stimulated and spontaneous emission.

15. Exciton THz laser according to claim 14, wherein the laser features a control or/and regulation to increase the release of electromagnetic energy, which hold the laser for a certain period of time below the “lasing threshold” in order to then cross it—for a short period of time—and to achieve a very highly stimulated emission.

16. Emitter elements according to claim 11, wherein the emitter element features the means or is assigned to the means to periodically or/and permanently release pressure fluctuations or/and temperature fluctuations onto the active material, in order to enable a modification of the emitted electromagnetic radiation.

17. (canceled)

18. Method according to claim 3, where each of the at least one s excitonic resonance is conducted in a pulsed and continuous manner.

19. In a method of generating a population in at least one exciton p-state in one or more of the fields of medical imaging, diagnostic and therapy, DNA analysis, quality control, and security technology, the improvement comprising generating the population according to claim 1.

20. In a method of generating a population in at least one exciton p-state in one or more of the fields of medical imaging, diagnostic and therapy, DNA analysis, quality control, and security technology, the improvement comprising generating the population according to claim 10.

21. In a device for generating a population in at least one exciton p-state in one or more of the fields of medical imaging, diagnostic and therapy, DNA analysis, quality control, and security technology, the improvement comprising using the device according to claim 11.

22. In a device for the generation of a population inversion in comparison to a equilibrium state between two energetically spaced exciton states, and generating a population in at least one exciton p-state in one or more of the fields of medical imaging, diagnostic and therapy, DNA analysis, quality control, and security technology, the improvement comprising using an amplifier according to claim 13.
